(19) United States
(12) Patent Application Publication
(10) Pub. No.: US 2020/0317823 A1
(43) Pub. Date: Oct. 8, 2020

(54) PROCESS FOR DRYING A NATURAL RUBBER

(71) Applicant: COMPAGNIE GENERALE DES ETABLISSEMENTS MICHELIN, Clermont-Ferrand (FR)

(72) Inventors: Jérôme DUSSILLOLS, Clermont-Ferrand Cedex 9 (FR); Jean-Luc MERCERON, Mozac (FR); Sébastien GEFFROY, Clermont-Ferrand Cedex 9 (FR); Alexandre MARCHI, Clermont-Ferrand Cedex 9 (FR)

(73) Assignee: Compagnie Generale des Etablissements Michelin, Clermont-Ferrand (FR)

(21) Appl. No.: 16/304,841

(22) PCT Filed: May 30, 2017
(86) PCT No.: PCT/FR2017/051340

§ 371 Date: Nov. 27, 2018

(30) Foreign Application Priority Data
May 31, 2016 (FR) 1654878

(51) Int. Cl. C08C 3/00; B29B 9/12; B29B 13/06; B29B 13/02; B29B 9/06

(52) U.S. Cl. CPC C08C 3/00; B29B 9/12; B29B 2013/002; B29B 13/02; B29B 9/06; B29B 13/06

(57) ABSTRACT

A process for drying a natural rubber starting from a wet natural rubber coagulum is provided. In a first step, the wet natural rubber coagulum is compressed at a temperature ranging from 185° C. to 210° C., then in a second step subjected to a flash adiabatic expansion at a differential pressure of at least 100 bar. Optionally supplemented by convective drying or by repeating the first and second steps, the process leads to a dry natural rubber having a nitrogen content of at most 0.3%.

This application is a 371 national phase entry of PCT/FR2017/051340 filed on 30 May 2017, which claims benefit of French Patent Application No. 1654878, filed 31 May 2016, the entire contents of which are incorporated herein by reference for all purposes.

### BACKGROUND

### 1. Technical Field

The invention relates to a process for drying a natural rubber starting from a natural rubber coagulum.

### 2. Related Art

Natural rubber, which contains a polyisoprene matrix with a high cis content, is a very widely used elastomer in the tyre field due to its noteworthy properties. For example, it is used in rubber compositions intended for the manufacture of semi-finished products for vehicles transporting heavy loads, due to the performance compromise that it may afford the tyre. Indeed, introducing natural rubber into a rubber composition reinforced by a reinforcing filler such as a carbon black confers a very beneficial compromise upon the rubber composition in terms of hysteresis and wear, which is reflected in terms of tyre performance by a good compromise between endurance and wear of the tyre.

Natural rubber originates from the dry rubber material of natural rubber latex, which is commonly extracted from Hevea following tapping: the latex is generally collected in a receptacle referred to as a cup. According to a first coagulation process, referred to as spontaneous, the latex coagulates directly in the cup to form a “cup lump” coagulum, a term which is well known to those skilled in the art of producing natural rubber. According to a second coagulation process, referred to as induced, the still-liquid latex in the cup is decanted, optionally stabilized or centrifuged, then coagulated for example by means of a chemical agent.

The spontaneous or induced coagulation product of the natural rubber latex, hereinafter referred to as the coagulation product, comprises the polyisoprene matrix soaked in a serum. The coagulation product may be washed to remove contaminants such as leaves, twigs, sand and other debris, but it may also be shredded into the form of crumbs, washed with water in pools, optionally drained, and finally dried to remove water. There are several drying processes used to remove water from natural rubber, which are widely known and practised by those skilled in the art of producing natural rubber, especially for producing the grades TSR3, TSR5, TSR10, TSR20 or RSS. According to the processes traditionally used at sites for producing natural rubber, the coagulation product is dried at a moderate temperature of the order of 40 to 60° C. for 4 to 6 days, for example in the open air or in smoke houses, or else at a higher temperature, typically from 90 to 130° C., for a much shorter time in tunnels with circulating air.

These traditionally used drying steps have the drawback of comprising long drying times, or of degrading the macrostructure of the polyisoprene chains of the natural rubber, or of decreasing the resistance of the natural rubber to ageing by oxidation.

In order to solve the abovementioned problems, drying natural rubber by means other than traditional processes has been described. For example, document JP 2010-260930 teaches drying the coagulation product in an extruder by draining at 130° C., then on a vibrating sieve at a temperature of at most 130° C. Document US 20130032045 describes a process which comprises draining the coagulation product in an extruder, then removing the residual water at temperatures from 140 to 180° C. and at pressures from 15 to 20 MPa in an elongated tunnel structure comprising a screw.

Moreover, it is known that natural rubber latex contains nitrogenous compounds such as proteins. The presence of these nitrogenous compounds in natural rubber, the content of which in the natural rubber is measured by the nitrogen content in the natural rubber, may be the source of allergies observed on contact with products manufactured using natural rubber, such as gloves. Since the content of nitrogenous compounds in natural rubber is correlated with the content of nitrogen in natural rubber, it is therefore an ongoing concern to reduce the nitrogen content in natural rubber. Reducing the nitrogen content by chemical treatments carried out on natural rubber latex or on the coagulation product is known, especially by saponification reaction or by enzymatic reaction, as is described for example in documents EP 584 597 and WO 2005590412. The drawback of these technologies is the introduction of at least one additional step, on top of the steps of washing and drying, in the process for producing natural rubber.

It is therefore beneficial to find a process which makes it possible to solve all the problems mentioned, which are associated with the removal of water and nitrogenous compounds from natural rubber, while retaining the properties of the natural rubber.

### SUMMARY

The Applicants have discovered, surprisingly, that applying an expansion to a natural rubber coagulum under specific temperature and pressure conditions, optionally supplemented with convective drying or one or more new expansions, makes it possible to both remove water from, and reduce the nitrogen content in, natural rubber. Typically, at the end of the process in accordance with the invention, the water content in the natural rubber is less than 0.8% and the nitrogen content is at most 0.3%, preferably ranging from 0.2% to 0.3%. Preferential embodiments of the invention make it possible to achieve as low a residual water content and an even lower nitrogen content, namely a residual water content of less than 0.8% and a nitrogen content of less than 0.3%, especially of between 0.2% and 0.3%. Moreover, the Applicants have discovered that the natural rubber resulting from preferential variants of the process in accordance with the invention has a better resistance to ageing by oxidation and also a high number-average molar mass.

Thus, a first subject of the invention is a process for drying a natural rubber, which comprises the following steps:
a) providing a wet natural rubber coagulum,
b) compressing the coagulum at a temperature ranging from 185° C. to 210° C.,
c) subjecting the compressed coagulum to a flash adiabatic expansion at a differential pressure of at least 100 bar,
d) where appropriate, subjecting the coagulum resulting from step c) to convective drying or to one or more repetitions of the sequence of steps b) and c).

Another subject of the invention relates to a natural rubber which may be obtained by preferential embodiments of the process in accordance with the invention and which has the particular feature of having a number-average molar mass of greater than 1 000 000, a nitrogen content of less than 0.3% and a plasticity retention index of greater than 100.

### DETAILED DESCRIPTION OF EXAMPLE EMBODIMENTS OF THE INVENTION

Any range of values denoted by the expression “between a and b” represents the field of values ranging from more than a to less than b (that is to say limits a and b excluded) whereas any range of values denoted by the expression “from a to b” means the field of values ranging from a up to b (that is to say including the strict limits a and b). Unless expressly indicated otherwise, all percentages (%) indicated are wt %.

In the present application, natural rubber latex is intended to mean the latex resulting from tapping the Hevea.

In the present application, extruder is intended to mean a machine with an endless screw, which comprises a material inlet referred to as a hopper, a body formed from a cylinder (also referred to as a barrel), in which an endless screw (one or more) turns, and a head which serves to support a die. This machine makes it possible to apply mechanical drying or thermomechanical drying. Mechanical drying enables the removal of liquid by purely mechanical means (pressing, draining, etc.). It may be carried out simply by momentum transfer and optionally without heat transfer. Thermomechanical drying is carried out by heating, transferred to the product to be dried by degradation of mechanical energy. The water included in the product to be dried is in the liquid state under high pressure and at high temperature. At the outlet of the die, the expansion produced makes it possible to flash the moisture and, where appropriate, depending on the viscosity of the product, to fragment the product.

The process in accordance with the invention is suited to drying a coagulum, the water content of which in step a) is from 3 to 5%. It is also suited to drying a coagulum, the water content of which in step a) is greater than 5%. It is also entirely suited to drying a coagulum, the water content of which in step a) is greater than 12%.

The process in accordance with the invention makes it possible to obtain a dry natural rubber, that is to say a natural rubber with a water content of less than 0.8%. The process also makes it possible to produce not only a dry natural rubber, but also a natural rubber in which the nitrogen content is reduced. The process in accordance with the invention makes it possible to reduce the nitrogen content in the natural rubber by at least 20%, or even more, since the reduction in the nitrogen content may be as much as 40%. The magnitude of the reduction depends on the nitrogen content present in the natural rubber used in step a). The higher the nitrogen content in the natural rubber used in step a), the greater the reduction in the nitrogen content in the natural rubber dried by the process in accordance with the invention.

Indeed, the nitrogen content in the natural rubber used in step a) may vary from one natural rubber to another. It may depend on the geographical region in which the Hevea is grown, on the Hevea plant variety, on the season in which tapping was carried out, and on the maturation time, which generally corresponds to the amount of time between tapping and remilling of the natural rubber. It is recalled that remilling is the well known and well used term to describe the set of treatment operations which comprises the steps of grinding, washing and drying.

The nitrogen content of the natural rubber used in step a) may therefore range from 0.25% to more than 0.3%, the low value possibly corresponding to longer maturation times. The nitrogen content in the natural rubber used in step a) is preferably greater than 0.3%, especially greater than or substantially equal to 0.4%. Thus, the process in accordance with the invention makes it possible to obtain a dry natural rubber with a nitrogen content of at most 0.3%, preferably ranging from 0.2% to 0.3%, more preferentially of between 0.2% and 0.3%.

The coagulum used in step a) (or, in other words, which is provided in step a)) is a coagulation product of the natural rubber latex, regardless of whether it was obtained by spontaneous or induced coagulation. The coagulum is preferably a cup lump coagulum.

The coagulum is said to be wet because it is soaked in water, which originates especially from the washing waters resulting from the operations for washing the coagulum, which are generally carried out in pools under water. The coagulum used in step a) is preferably a coagulum which has undergone washing operations and generally contains more than 12% by weight of water. The water content in the coagulum used in step a) is more preferentially from 17 to 25%, such water contents being those generally metered in coagulums after the washing operations in the natural rubber remilling plants.

The coagulum used in step a) is preferably in the form of crumbs. More preferentially, the coagulum used in step a) is in the form of crumbs washed beforehand in water and consequently loaded with water, especially at the contents given above, in particular greater than 12%.

Step b) of the process in accordance with the invention is a compression of the coagulum. This compression is necessary to be able to subsequently subject the coagulum to an adiabatic expansion. The pressure at which the coagulum is compressed must be sufficient to enable an adiabatic expansion at a differential pressure of at least 100 bar. The coagulum is compressed at a pressure preferentially of at least 100 bar, more preferentially of at least 120 bar, even more preferentially of at least 150 bar.

The compression may be carried out by any means known for pressurizing a rubber material soaked in water. As suitable means, mention may be made of presses such as those consisting of jaws or plates which sandwich the coagulum, or endless screw machines fitted with a die at the screw end. In order to achieve the pressures which can be used for the purposes of the invention at the screw end in an endless screw machine, those skilled in the art may adjust, for example, the coagulum flow rate in the endless screw machine, the speed of the screw, the geometry thereof, the shape of the holes in the die, or the number or diameter thereof. An extruder fitted at one screw end with a die comprising several holes is most particularly preferred.

At the pressure which can be used for the purposes of the invention in order to carry out compression, the coagulum is brought to a temperature ranging from 185 to 210° C. In an endless screw machine as extruder, mechanical work under high pressure is accompanied by heating of the rubber material of the coagulum, which has the effect of increasing the temperature of the coagulum. The temperature must not exceed 210° C., so as not to degrade the polyisoprene chains. Below 185° C., the amount of heat supplied to the coagulum is insufficient to cause both vaporization of the water and removal of a portion of the nitrogenous compounds from the natural rubber during the expansion. The temperature is preferably at least 190° C., which makes it possible to thereby increase the effectiveness of the process. Thus, according to a preferential embodiment, the coagulum is compressed in step b) at a temperature ranging from 190° C. to 210° C. In order to achieve the temperatures which can be used for the purposes of the invention, heat may also be supplied by heating the means used to carry out the compression, for example by heating the jaws or plates of a press machine, or the inside of a screw machine such as the barrel of an extruder, by means of a jacket.

The length of time for which the coagulum is subjected to the compression at the temperature and at the pressure which can be used for the purposes of the invention is relatively short, so as not to degrade the polyisoprene chains, but is sufficient to supply enough heat to cause vaporization of the water and removal of a portion of the nitrogenous compounds during the expansion.

The adiabatic expansion carried out in step c) is characterized as flash expansion in that it enables the coagulum to go from a compressed state to a non-compressed state virtually instantaneously, typically in a length of time of less than a second. It is carried out at a differential pressure of at least 100 bar, which makes it possible to vaporize the water and to remove a portion of the nitrogenous compounds by a flash effect. The greater the differential pressure, the more effective is the flash at reducing the amount of water and the nitrogen content in the natural rubber. The differential pressure is preferably at least 150 bar. Since the expansion is adiabatic, the expansion occurs at the temperature at which the compression was carried out. At the end of expansion, the coagulum is generally at atmospheric pressure. In the case in which an extruder fitted with a die at the screw end is used to carry out step b), the flash adiabatic expansion in step c) occurs at the die outlet. The stresses hitherto exerted on the coagulum in the barrel are released at the die outlet by suppressing the compression, which enables the flash adiabatic expansion at the die outlet. In the case in which a press is used to compress the coagulum, the release of the stresses is caused by the rapid opening of the press.

At the moment of the expansion carried out in step c), the greater the outer surface of the coagulum on contact with the atmosphere is, then the greater the exchange surface of the coagulum with the atmosphere is, and the more effective the process is at reducing the amount of water and the nitrogen content in the natural rubber. Consequently, it is preferable for the coagulum to have as large a surface per unit volume as possible in step c). For example, in the case of an expansion at the die outlet of an extruder, the coagulum is advantageously in a divided form in step c). Typically, the coagulum may be cut just before the expansion, by installing means able to cut the coagulum at the die outlet, such as a blade or pelletizer, preferentially a pelletizer. Such devices comprising a pelletizer at the die outlet at the screw end of an extruder are well known for their use in processes for producing synthetic rubbers. In the case in which a press is used as means for pressurising the wet coagulum, the exchange surface of the coagulum with the ambient atmosphere is renewed before each new cycle of compression and expansion, for example by folding the surface of the coagulum over on itself before compressing it again. This surface renewal also makes it possible to improve the effectiveness of the process which uses a press.

According to a first alternative, step d) consists in drying the coagulum by convection. Any known convection drying means may be suitable. In particular, a fluidized bed such as a vibrating sieve is preferred, which is a known device conventionally used in processes for producing synthetic rubbers. The convective drying is preferably carried out under air. The convective drying under air is preferably carried out at a temperature ranging from 110° C. to 130° C. The length of time for drying by convection is adjusted by those skilled in the art as a function of the drying temperature in step d) and as a function of the residual water content in the coagulum at the end of step c). It is preferred to apply as short a drying time as possible in step d) in order to conserve the structure of the polyisoprene chains of the natural rubber, and its properties. Typically, the length of time for drying by convection is less than 10 minutes so as to obtain a natural rubber containing less than 0.8% water.

According to a second alternative, step d) consists in subjecting the coagulum to another compression followed by another expansion under the conditions described for step b) and step c), respectively. Where appropriate, it may prove necessary to repeat this sequence of steps to achieve both a water content in the natural rubber of less than 0.8% and a reduction of the nitrogen content in the natural rubber by at least 20%.

According to one embodiment, step d) is carried out. Carrying out step d) is expedient depending on the residual water content obtained at the end of step c) of the process. The water content in the natural rubber at the end of step c) depends not only on the pressure and temperature conditions applied in steps b) and c) but also on the initial value of water in the coagulum used in step a). Those skilled in the art will clearly understand that the greater the load of water in the coagulum in step a), the higher the residual water content may be at the end of step c), and that it may then be necessary to carry out a supplementary drying, step d). For example, the treatment according to the process of two coagulums loaded with 3 to 5% water for the first, and more than 12% water for the second, leads, at the end of step c), to a residual water content of less than 0.8% for the first and from 3 to 5% for the second. In the case of the second coagulum, step d) proves necessary to reduce the water content to a value of less than 0.8%.

In order to supplement the drying of a coagulum resulting from step c), those skilled in the art preferentially choose one alternative rather than the other, taking into account the residual water content and the nitrogen content in the natural rubber. Since drying by convection can only ensure removal of the water, it is preferred to supplement the drying of a coagulum resulting from step c), the nitrogen content of which is at most 0.3% and the water content of which is within a range extending from 3 to 5%. This is typically the case when step c) is carried out in an extruder fitted with a die at the screw end and with a tool for cutting the coagulum, such as a pelletizer.

A divided form of the coagulum is preferred in step d), whether it is carried out according to the first or the second alternative. For the same reasons as those highlighted in step c), it makes it possible to improve the effectiveness of step d) in obtaining a residual water content of less than 0.8% in the natural rubber, especially by reducing the duration of step d).

The extruder which can be used for the purposes of the invention may be a commercially available extruder, especially those sold by Anderson, FOM and Welding, such as, for example, the Expander from Anderson, the Extruder Dryer from FOM or the VCU from Welding. Variants of extruders are preferential in that they make it possible, at the die outlet, to achieve higher flow rates of coagulum or to promote the adiabatic expansion. Such a preferential variant is an extruder, the barrel of which has, in the supply zone of the extruder, a (one or more) means for evacuating water (free water in liquid form). As evacuation means, mention may be made of grooves in the thickness of the barrel which open out onto the inner surface of the barrel, one or more openings in the supply zone of the extruder, which opening makes it possible to evacuate the water from the barrel. These openings may be in the form of slits, grating, or circular holes. The supply zone is the zone which is located under the opening of the hopper.

The extruder which can be used for the purposes of the invention is preferably a single-screw extruder.

According to a particular embodiment, the process in accordance with the invention has the advantage of being able to be carried out with a device comprising a single endless screw machine and a hot air fluidized bed, the endless screw machine being an extruder fitted at one screw end with a perforated die and with a means able to cut the coagulum, arranged after the die, which means is preferably a pelletizer.

According to a variant of this particular embodiment, the barrel of the extruder has, in the supply zone of the extruder, one or more means for evacuating water, for example those mentioned above.

According to another variant of this particular embodiment, the extruder is a single-screw extruder.

According to another variant of this particular embodiment, the extruder comprises a jacket.

According to yet another variant of this particular embodiment, the hot air fluidized bed is a vibrating sieve.

According to this particular embodiment, including in the variants thereof, which may be combined, the process makes it possible to remove the water and a portion of the nitrogenous compounds from a coagulum in the form of crumbs loaded with water at a content of greater than 12%. Indeed, it makes it possible to obtain a natural rubber having a water content of less than 0.8%, a nitrogen content of less than 0.3%, a weight-average molar mass of greater than 1 000 000 g/mol and a plasticity retention index of greater than 100.

According to this particular embodiment, including in the variants thereof described above, the process preferably comprises steps a), b), c) and d), steps a), b) and c) being as defined according to any one of the embodiments of the invention, step d) being defined according to the alternative, including the preferential aspects thereof, which relies on drying by convection.

The natural rubber, another subject of the invention, has the essential feature of having a weight-average molar mass of greater than 1 000 000 g/mol, a water content of less than 0.8%, a nitrogen content of less than 0.3% and a plasticity retention index (PRI) of greater than 100. The natural rubber which may be obtained according to preferential embodiments of the invention has greatly improved properties in comparison to the natural rubber dried according to conventional processes, such as a TSR20-grade natural rubber. Indeed, the natural rubber in accordance with the invention has a greatly improved resistance to ageing by oxidation, due to the high PRI value. The PRI is the ratio, expressed as a percentage, of the plasticity of aged natural rubber over the plasticity of natural rubber before ageing. The determination thereof, according to standard ASTM D 3194-04, is used to give an indication of the resistance to oxidation of the natural rubber. The greater the value, the better the resistance to ageing by oxidation. The natural rubber in accordance with the invention preferably has a nitrogen content of between 0.2 and 0.3%.

The abovementioned characteristics of the present invention, and also others, will be better understood on reading the following description of several exemplary embodiments of the invention, given by way of illustration and without limitation.

### Exemplary Embodiments of the Invention

### 1.—Method for Characterizing Natural Rubbers:

1.a—Nitrogen Content:

The nitrogen content was measured according to standard ASTM D 3533-90.

1.b—Water Content:

The water content is determined with a Mettler Toledo HB43-S halogen desiccator. The desiccator is an automated device which incorporates a crucible, a balance and a cover intended to close the crucible. The crucible is positioned on the balance. The cover comprises a means for heating by a halogen lamp, this heating means being triggered when the cover is lowered onto the crucible. In the crucible, a sample of 10 grams of natural rubber are weighed exactly: the device records the weight corresponding to “a”. The cover is lowered to close the crucible, which triggers the temperature rise to reach a setpoint of 160° C. When the device detects a reduction in weight of less than 0.001 g per minute, the device takes a reading of a weight “b”. The water content in the sample is given as percentage by weight by the following equation:

Water content (%)=100*((a−b)/a)

1.c—Characterization of the Macrostructure of Natural Rubbers by SEC-RI-MALS Analysis (Size Exclusion Chromatography—Differential Refractive Index Detectors—Multiangle Light Scattering Detector):

The samples of natural rubber were dissolved in a solvent (tetrahydrofuran, THF) for 7 days at 25° C. at a concentration of 5 mg/ml. The soluble fraction is collected and the concentration is adjusted to 2 mg/ml. After filtration at 0.45 μm, 100 μl are injected into a set of columns consisting of four columns from Polymer Lab (2 PLgel Mixed A columns and 2 PLgel mixed B columns), the elution solvent being stabilized tetrahydrofuran (250 ppm of BHT), the flow rate being 0.5 ml/min, the temperature of the system being 35° C., and the duration of analysis being 90 min. A dual detection system is used: a differential refractometric concentration detector (Optilab T-rEX from Wyatt) and a multiangle light scattering detector (Dawn Heleos from Wyatt). The data are processed using the Astra software and make it possible to obtain: the number-average molar mass (Mn), the weight-average molar mass (Mw) and the polydispersity (PDI) of the samples analysed.

1.d—Plasticity Retention Index (PRI):

This is measured according to standard ASTM D 3194-04.

1.e—Mooney Plasticity:

Use is made of an oscillating consistometer as described in French standard NFT 43-005 (November 1980). The Mooney plasticity measurement is carried out according to the following principle: the natural rubber is moulded in a cylindrical chamber heated to 100° C. After preheating for one minute, the rotor rotates within the test specimen at 2 revolutions/minute and the working torque for maintaining this movement is measured after 4 minutes of 8 rotations. The Mooney plasticity (ML 1+4) is expressed in “Mooney unit” (MU, with 1 MU=0.83 newton·metre).

### 2—Example of Drying in a Press:

20 g of cup lump coagulum crumbs having a water content of greater than 12% and a nitrogen content of 0.41% are compressed, which crumbs are arranged between two plates of a press arranged horizontally and heated to a given temperature, indicated in table 1 for each of the tests 1 to 5. A pressure of 150 bar is applied for 1 minute (length of time enabling the coagulum to be brought to the temperature of the press), following which the press is opened very rapidly (in less than a second) in order to remove the pressure on the coagulum and produce the flash adiabatic expansion. The compression and expansion operation is repeated 1 to 3 times by opening the press according to the same operating procedure described above, as indicated in table 1. Between each cycle of compression-expansion, the rubber is folded over on itself to renew the exchange surface.

After each cycle of compression and expansion, the nitrogen content in the natural rubber is measured.

TABLE 1

| | Temperature | Number of | Nitrogen content |
|---|---|---|---|
| | (° C.) | repetitions | (%) |
| Test 1 | 150 | 1 | 0.38 |
| | | 2 | 0.37 |
| | | 3 | 0.40 |
| Test 2 | 170 | 1 | 0.34 |
| | | 2 | 0.32 |
| | | 3 | 0.33 |
| Test 3 | 190 | 1 | 0.38 |
| | | 2 | 0.31 |
| | | 3 | 0.25 |
| Test 4 | 200 | 1 | 0.39 |
| | | 2 | 0.32 |
| | | 3 | 0.30 |
| Test 5 | 210 | 1 | 0.33 |
| | | 2 | 0.29 |
| | | 3 | 0.29 |

Tests 1 and 2 are not in accordance with the invention, because the coagulum is compressed at a temperature of 150 and 170° C., respectively. Tests 3 to 5 are in accordance with the invention, because the coagulum is compressed at a temperature of 190, 200 and 210° C.

After 3 repetitions, all the natural rubbers have a water content of less than 0.8%. On the other hand, only the tests in accordance with the invention lead to obtaining a natural rubber having a nitrogen content of at most 0.3%. It is noted that a temperature of 170° C. in step b) is insufficient to reduce both the water content and the nitrogen content. It is noted that the tests for which the temperature in step b) is at least 185° C. make it possible to reduce both the water content and the nitrogen content: tests 3 to 5 make it possible to obtain a natural rubber having both a water content of less than 0.8% and a nitrogen content of at most 0.3%.

3—Example of Drying in an Extruder Fitted with a Perforated Die at the Screw End and with a Pelletizer, Followed by Drying on a Vibrating Sieve:

An extruder is supplied with a cup lump coagulum in crumb form, having a water content of greater than 12% and a nitrogen content of 0.38%. The extruder is a single-screw extruder, fitted with a perforated die at the screw end and with a pelletizer arranged at the die outlet. The extruder comprises a jacket, and its barrel has, in the supply zone, means for evacuating water (grooves, slits, holes). The speed of the screw is 150 rpm, the pressure is 155 bar, the temperature of the coagulum is 194° C., the temperature and the pressure being measured by sensors positioned as close as possible to the die, between the die and the end of the screw which is closest to the die. Once it has left the extruder, the coagulum in the form of crumbs is dried on a vibrating sieve in hot air at a temperature of 130° C. for approximately 5 minutes. The natural rubber having the following characteristics is recovered:

| | | |
|---|---|---|
| Water content: 0.4% | Nitrogen content: 0.28% | PRI: 109 |
| Mn: 890 000 g/mol | Mw: 1 250 000 g/mol | ML: 62 |

Instead of being dried according to the procedure described above in accordance with the invention, the same starting coagulum as that used to supply the extruder, also in the form of crumbs, was dried according to a traditional process conventionally used to produce the TSR20 grade, that is to say drying in a tunnel under hot air at a temperature ranging from 108° C. to 125° C. for 4 and a half hours. The natural rubber resulting from this process has the following characteristics:

| | | |
|---|---|---|
| Water content: 0.6% | Nitrogen content: 0.38% | PRI: 64 |
| Mn: 582 000 g/mol | Mw: 898 000 g/mol | ML: 71 |

It is observed that, unlike the drying process traditionally used to produce the TSR20 grade, the process in accordance with the invention makes it possible to obtain a natural rubber which is not only dried (water content of less than 0.8%) but also which has a reduced nitrogen content which is at most 0.3%, a weight-average molar mass of greater than 1 000 000, and a plasticity retention index of greater than 100.

1. A process for drying a natural rubber, which comprises the following steps:
a) providing a wet natural rubber coagulum,
b) compressing the coagulum at a temperature ranging from 185° C. to 210° C.,
c) subjecting the compressed coagulum to a flash adiabatic expansion at a differential pressure of at least 100 bar,
d) where appropriate, subjecting the coagulum resulting from step c) to convective drying or to one or more repetitions of the sequence of steps b) and c).

2. A process according to claim 1, in which the temperature is from 190° C. to 210° C. in step b).

3. A process according to claim 1, in which the differential pressure is at least 150 bar in step c).

4. A process according to claim 1, in which the coagulum is at atmospheric pressure at the end of expansion.

5. A process according to claim 1, in which step d) is carried out.

6. A process according to claim 5, in which step d) is convective drying.

7. A process according to claim 6, in which the convective drying is carried out under air at a temperature ranging from 110° C. to 130° C.

8. A process according to claim 1, in which the coagulum used in step a) has a water content of greater than 12% by weight.

9. A process according to claim 1, in which the coagulum used in step a) has a water content of greater than 5% by weight.

10. A process according to claim 1, in which the coagulum used in step a) has a water content ranging from 3 to 5% by weight.

11. A process according to claim 1, in which the coagulum used in step a) is a cup lump coagulum.

12. A process according to claim 1, in which the coagulum used in step a) is in the form of crumbs.

13. A process according to claim 1, which process is carried out with a device comprising a single endless screw machine and a hot air fluidized bed, the endless screw machine being an extruder fitted at one screw end with a perforated die and with a means able to cut the coagulum, arranged after the die.

14. A process according to claim 13, in which the means able to cut the coagulum is a pelletizer.

15. A process according to claim 13, in which the extruder comprises a barrel which has, in the supply zone of the extruder, one or more means for evacuating water.

16. A process according to claim 13, in which the extruder is a single-screw extruder.

17. A process according to claim 13, in which the extruder comprises a jacket.

18. A process according to claim 13, in which the hot air fluidized bed is a vibrating sieve.

19. A natural rubber having a weight-average molar mass of greater than 1 000 000 g/mol, a water content of less than 0.8% by weight, a nitrogen content of less than 0.3% by weight and a plasticity retention index of greater than 100.

20. A natural rubber according to claim 19, in which the nitrogen content is between 0.2 and 0.3% by weight.
